(19) United States
(12) Patent Application Publication
(10) Pub. No.: US 2004/0091754 A1
(43) Pub. Date: May 13, 2004

(54) Method for operating a fuel cell arrangement and fuel cell arrangement for carrying out the method

(76) Inventors: Willi Bette, Erlangen (DE); Arno Mattejat, Bubenreuth (DE); Walter Stuhler, Hirschaid (DE)

Correspondence Address: HARNESS, DICKEY & PIERCE, P.L.C., P.O.BOX 8910, RESTON, VA, 20195, US

(21) Appl. No.: 10/381,464

(22) PCT Filed: Sep. 14, 2001
(86) PCT No.: PCT/DE01/03541

(30) Foreign Application Priority Data
Sep. 26, 2000 (DE) 100 47 589.2

(51) Int. Cl. H01M 8/04

(52) U.S. Cl. 429/13; 429/22

(57) ABSTRACT

The invention relates to a method for operating a fuel cell arrangement and to a fuel cell arrangement for carrying out the method. A fuel cell arrangement (1) comprising a number of fuel cells that are located in a protective housing (4) is to be operated with a high degree of operating reliability and a particularly long service life. To this end, at least a proportion of the gas that is located in the inner area (6) enclosed by the protective housing (4) is guided out of the inner area (6) and replaced with fresh gas.

The invention relates to a method for operating a fuel cell arrangement having a number of fuel cells arranged in a protective housing. It also relates to a fuel cell arrangement of this type.

Fuel cells can be used for the environmentally friendly generation of electricity. This is because a process which substantially represents a reversal of electrolysis takes place in a fuel cell. For this purpose, in a fuel cell, a fuel which includes hydrogen is fed to an anode and an auxiliary substance which includes oxygen is fed to a cathode. The anode and cathode are electrically separated from one another by an electrolyte layer; although the electrolyte layer does allow ion exchange between the fuel and the oxygen, it otherwise ensures gas-tight separation of fuel and auxiliary substance. On account of the ion exchange, hydrogen contained in the fuel can react with the oxygen to form water, during which process electrons accumulate at the fuel-side electrode or anode and electrons are depleted at the electrode on the auxiliary-substance side, i.e. the cathode. Therefore, when the fuel cell is operating a usable potential difference or voltage is built up between the anode and cathode, while the only waste product from the electricity generation process is water. The electrolyte layer, which in the case of a high-temperature fuel cell may be designed as a solid ceramic electrolyte or in the case of a low-temperature fuel cell may be designed as a polymer membrane, therefore has the function of separating the reactants from one another, of transferring the charge in the form of ions and of preventing an electron short circuit.

On account of the electrochemical potentials of the substances which are usually used, in a fuel cell of this type, under normal operating conditions, an electrode voltage of approximately 0.6 to 1.0 V can be built up and maintained during operation. For technical applications, in which a significantly higher overall voltage may be required depending on the intended use or the planned load, therefore, it is usual for a plurality of fuel cells to be connected electrically in series, in such a manner that the sum of the electrode voltages which are in each case supplied by the fuel cells corresponds to or exceeds the required total voltage. Depending on the total voltage required, the number of fuel cells in a fuel cell stack of this type may, for example, be 50 or more.

In a fuel cell arrangement, a fuel cell or a number of fuel cells which have been connected up in this manner to form a fuel cell stack can be enclosed in a protective housing for protection against mechanical damage and/or environmental influences, such as for example spray water or dirt. A protective housing of this type usually surrounds its interior space in a gas-tight and/or water-tight manner, the fuel cell or the fuel cells which have been combined to form a fuel cell stack being arranged in the interior space of the protective housing.

The invention is based on the object of describing a method for operating a fuel cell arrangement having a number of fuel cells arranged in a protective housing which, while achieving a high operational reliability, allows the fuel cell arrangement to have a particularly long service life. Moreover, it is intended to describe a fuel cell arrangement which is particularly suitable for carrying out the method.

With regard to the method, this object is achieved, according to the invention, through the fact that at least a proportion of the gas located in the interior space surrounded by the protective housing is discharged from the interior space and replaced by fresh gas.

The invention is based on the consideration that, to achieve a particularly long durability of the fuel cell arrangement, the fuel cells arranged in the interior space of the protective housing should as far as possible be kept away from effects which have a detrimental influence on their operational reliability. Particularly in the case of a plurality of fuel cells arranged in a common protective housing, however, there are relatively large numbers of connections and feedlines via which operating substances are fed to the corresponding fuel cell. Even if these feeds are provided with highly effective seals, damage or aging can nevertheless lead to leaks which, for example, can lead to the penetration of water or a mixture of fuel and oxygen-containing auxiliary substance into the interior space surrounded by the protective housing. As a result, the fuel cells arranged therein may be exposed to influences which have an adverse effect on their durability as a result of corrosion, or alternatively an ignitable, explosive mixture of molecular hydrogen and molecular oxygen may form. Moreover, in the event of liquid collecting in the interior of the protective housing, the insulating action of insulating substances may be adversely affected or it is even possible that a short circuit may occur. To avoid these factors which have an adverse effect on the durability of the fuel cell arrangement, the atmosphere in the interior space of the protective vessel should be regularly exchanged and/or have the components which have an adverse effect on the durability of the fuel cell removed from it.

The supply of fresh gas is effected particularly easily, for example, with the aid of a compressor or fan, which feeds the fresh gas to the protective housing under sufficient pressure.

If the fuel cell arrangement is operating in a vehicle, as an alternative sufficient pressure is built up with the aid of the airstream. Particles such as dust are expediently filtered out by a particle filter on the inlet side.

To achieve a particularly high reliability and operational stability, the proportion of gas is advantageously replaced by fresh gas on a regular basis. For this purpose, it is possible, in an advantageous refinement, for the replacement of the proportion of gas by fresh gas to be carried out continuously by means of an ongoing supply of an adjustable volumetric flow of fresh gas. The volumetric flow is expediently selected in such a manner that an accumulation of harmful components in the gas located in the interior space, for example as a result of leaks, is at least compensated for under standard conditions by the supply of the fresh gas.

In an alternative advantageous refinement, the replacement of the proportion of gas by fresh gas takes place after a predeterminable maintenance interval has elapsed, by exchanging substantially the entire atmosphere which fills the interior space. In this case, in a further expedient configuration, a build-up of pressure which occurs in the interior space before the maintenance interval has elapsed as a result of additional gas flowing into the interior space or as a result of temperature fluctuations is compensated for by means of a compensation vessel which is gas-connected to the interior space.

With regard to the fuel cell arrangement having a number of fuel cells arranged in a protective housing, a the object which is set is achieved through the fact that the interior space which is surrounded by the protective housing is gas-connected to an inlet line, which can be blocked off by means of a first control valve, and to an outlet line, which can be blocked off by means of a second control valve.

To compensate for any build-up of pressure in the interior space which may occur as a result of additional gas flowing into the interior space or as a result of temperature fluctuations, a compensation vessel is expediently gas-connected to the interior space.

A build-up of pressure of this type could occur in particular as a result of heating when temperature fluctuations occur, during which process a proportion of the gas located in the interior space is transferred into the compensation vessel. In the event of a subsequent temperature drop, however, the pressure in the interior space drops again, so that some of the gas flows back out of the compensation vessel into the interior space. To utilize this gas exchange between interior space and compensation vessel in a particularly advantageous way to purify the atmosphere in the interior space, a particle filter which is active on one side is expediently connected between the interior space and the compensation vessel. This particle filter is designed in such a manner that although the components which have an adverse effect on the internal fittings in the interior space, such as for example water, can flow through it from the interior space into the compensation vessel, they cannot flow through it in the opposite direction.

A sensor is expediently used to monitor a predetermined state parameter of the gas in the interior space of the protective housing, in which case the exchange of gas for fresh gas takes place in the event of a predetermined parameter value being exceeded. An example of a suitable state parameter is the hydrogen gas (H₂) content or humidity level in the gas, the temperature or the pressure of the gas. Exchanging the gas when the hydrogen content in the gas is too high ensures a high safety standard, since it is impossible for a combustible or explosive gas mixture to form in the protective housing. Monitoring the humidity level a in the gas has the advantage, for example, of achieving a low level of corrosion to the fuel cell arrangement.

If the gas is exchanged when a predetermined temperature is exceeded, overheating of the fuel cell arrangement is counteracted by cooling.

The advantages achieved by the invention consist in particular also in the fact that, as a result of the atmosphere which fills the interior space of the protective housing being at least partially exchanged, this atmosphere can reliably and permanently be kept pure. In particular, the ongoing or regular supply of dry fresh gas allows the water content of the atmosphere of the interior space to be kept at a relatively low level even in the event of small leaks which may occur, for example when fuel or auxiliary substances are fed to the fuel cells, so that there is no increased corrosion to the components arranged in the interior space of the protective housing. Furthermore, regular removal of molecular hydrogen and/or molecular oxygen from the interior space makes it possible to reliably avoid the formation of an explosive, ignitable mixture in the interior space of the protective vessel. The fuel cell arrangement designed in this way therefore has a particularly long service life in combination with a high operational reliability.

An exemplary embodiment of the invention is explained in more detail with reference to a drawing, in which

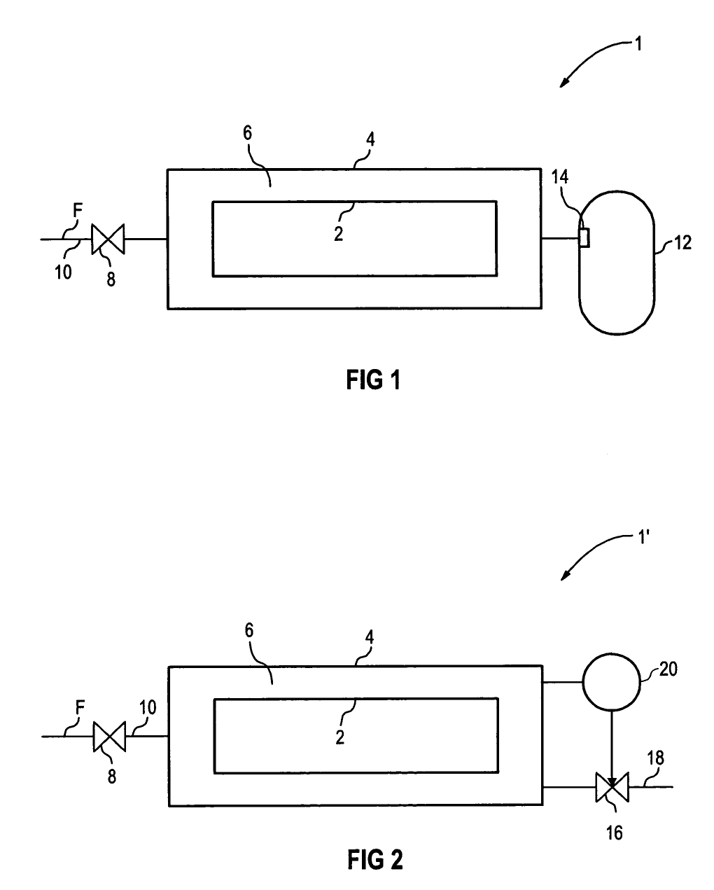

FIGS. 1 and 2 each diagrammatically depict a fuel cell arrangement.

Identical parts are provided with identical reference numerals in both figures.

The fuel cell arrangement 1 shown in FIG. 1 comprises a large number of fuel cells which are connected up to form a fuel cell block 2, which is diagrammatically indicated. Each fuel cell comprises an anode and a cathode as a pair of electrodes, it being possible for a fuel which includes hydrogen to be fed to the anode and an auxiliary substance which includes oxygen to be fed to the cathode, via a system of lines which is not shown in more detail. The anode and cathode of each fuel cell are electrically separated from one another by means of an electrolyte layer which, although it separates the fuel and auxiliary substance from one another in a gas-tight manner, does allow ion exchange between the fuel and the oxygen.

As a result of this ion exchange, an electrode voltage which amounts to between 0.6 and 1.0 V is established at the corresponding fuel cell. To generate a design voltage which is predetermined as a function of the intended use, the fuel cells in the fuel cell block 2 are electrically connected in series, in such a manner that the sum of their electrode voltages reaches or exceeds the output voltage required.

To protect against mechanical damage and also against environmental influences, such as spray water and dirt, the fuel cell block 2 is surrounded by a protective housing 4. The protective housing 4 has an interior space 6 which it surrounds and in which the fuel cell block 2 is arranged. The protective housing 4 surrounds, in a substantially gas-tight and water-tight manner, the interior space 6 and therefore also the fuel cell block 2 arranged therein, the feedlines which are required in order to supply the fuel cells of the fuel cell block 2 with fuel and auxiliary substance, as well as electrical connection lines for removing the electricity which is generated in the fuel cell block 2 and for supplying control signals, being guided through the outer walls of the protective housing 4.

The fuel cell arrangement 1 is designed for a particularly long durability in combination with high operational reliability. For this purpose, it is provided for the gas atmosphere which fills the interior space 6 to be kept relatively dry and free of components which attack the fuel cell block 2 arranged in the interior space 6. It is true that on the one hand environmental atmosphere can enter the interior space 6 as a result of the abovementioned supply and connection lines being led through the outer walls of the protective housing 4, on account of leaks which may occur at these locations. On the other hand, there is also a possibility of leaks when supplying the fuel cells of the fuel cell block 2 themselves, in which case, by way of example, water and/or fuel and/or auxiliary substance may enter the interior space 6. In this case, in particular after a relatively long maintenance-free operating period, a certain water content may accumulate in the atmosphere of the interior space 6, and this could expose the internal fittings in the interior space 6 and in particular the components of the fuel cell block 2 to increased levels of corrosion, thereby reducing their durability. Moreover, on account of a rising water content in the atmosphere of the interior space 6, the required insulation resistance may drop or the insulating actions of insulating materials may deteriorate, and consequently short circuits may also occur. As an alternative or in addition, in the event of a leak of fuel and auxiliary substance into the interior space 6, an ignitable mixture of molecular hydrogen and molecular oxygen could form in the interior space 6.

In order to safely and reliably avoid these disadvantageous effects on the durability and/or the operational reliability of the fuel cell arrangement 1, the design is such that the interior space 6 which is surrounded by the protective housing 4 can be fed with fresh gas F. For this purpose, the interior space 6 is gas-connected to an inlet line 10, which can be blocked off by means of a first control valve 8. To compensate for an increase in pressure which occurs in the interior space 6, for example as a result of temperature fluctuations, as a result of the supply of fresh gas F or as a result of leaks, the interior space 6 is also gas-connected to a pressure-compensation vessel 12.

When the fuel cell arrangement 1 as shown in FIG. 1 is operating, fresh gas F is fed to the interior space 6 of the protective housing 4 according to demand or events. As a result, a proportion of the gas located in the interior space 6 overflows into the pressure-compensation vessel 12, where components or gas fractions, such as for example water, which have an adverse effect on the internal fittings of the interior space 6 can be separated off. Moreover, the pressure-compensation vessel 12 is provided with a particle filter 14 which is active on one side and which, although it allows these components to overflow from the interior space 6 into the compensation vessel 12, prevents them from overflowing in the opposite direction. This ensures that even in the event of gas flowing back out of the compensation vessel 12 into the interior space 6, for example as a result of a pressure drop in the interior space 6 resulting from a temperature drop, the components or gas fractions which have an adverse effect in the interior space 6 remain in the compensation vessel 12. When the fuel cell arrangement 1 as shown in FIG. 1 is operating, the compensation vessel 12 is emptied at regular maintenance intervals.

The fuel cell arrangement 1′ as shown in FIG. 2, like the fuel cell arrangement 1, is designed for fresh gas F to be fed to the interior space 6 surrounded by the protective housing 4. For this purpose, the fuel cell arrangement 1′ is likewise connected to an inlet line 10, which can be blocked off by means of a first control valve 8, but on the outlet side it is also connected to an outlet line 18 which can be blocked off by means of a second control valve 16. The second control valve 16 can in this case be adjusted by means of a sensor 20 which is likewise gas-connected to the interior space 6 and is designed as a pressure sensor. It is equally possible for the sensor to be designed as a temperature sensor or a humidity- or hydrogen-sensitive sensor.

Therefore, an adjustable volumetric flow, which is approximately constant over the course of time, of fresh gas F can be fed to the fuel cell arrangement 1′ in the form of continuous operation. In this case, an approximately constant internal pressure can be maintained in the protective housing 4 by means of the pressure sensor 20 which acts on the second control valve 16, excess gas flowing out of the interior space 6 via the outlet line 18. In other words, in a long-term operating state, a constant, adjustable volumetric flow of fresh gas F can be fed to the interior space 6, replacing proportions of the gas located in the interior space 6. For this purpose, a volumetric flow of gas which corresponds to the volumetric flow of the fresh gas F flows out of the interior space 6 via the outlet line 18.

When the fuel cell arrangement 1, 1′ is operating, the gas atmosphere located in the interior space 6 surrounded by the protective housing 4 is at least partly replaced by fresh gas F at maintenance intervals or continuously. During this operation, undesirable impurities and in particular constituents which have an adverse effect on the durability and operational reliability of the fuel cell arrangement 1, such as in particular water and molecular hydrogen, are removed from the atmosphere in the interior space 6. As a result, an increase in the levels of the above-mentioned substances, which in turn could lead to corrosion or to the ability of individual components arranged in the interior space 6 to function being impaired, is prevented even over a prolonged operating time.

1. A method for operating a fuel cell arrangement (1) having a number of fuel cells arranged in a protective housing (4), in which at least a proportion of the gas located in the interior space (6) surrounded by the protective housing (4) is discharged from the interior space (6) and replaced by fresh gas.

2. The method as claimed in claim 1, in which the replacement of the proportion of gas by fresh gas is carried out continuously by means of the ongoing supply of an adjustable volumetric flow of fresh gas.

3. The method as claimed in claim 1, in which the replacement of the proportion of gas by fresh gas is carried out after a predeterminable maintenance interval has elapsed, by exchanging substantially the entire atmosphere which fills the interior space (6).

4. The method as claimed in claim 3, in which a build-up of pressure which occurs in the interior space (6) before the maintenance interval has elapsed as a result of additional gas flowing into the interior space (6) or as a result of temperature fluctuations is compensated for by means of a compensation vessel which is gas-connected to the interior space.

5. The method as claimed in claim 1, in which a sensor (20) monitors a predetermined state parameter of the gas and, in the event of a predetermined parameter value being exceeded, gas is exchanged for fresh gas.

6. The method as claimed in claim 5, in which the state parameter is the hydrogen gas content in the gas.

7. The method as claimed in claim 5, in which the state parameter is the humidity level in the gas.

8. A fuel cell arrangement (1) having a number of fuel cells arranged in a protective housing (4), in which the interior space (6), which is surrounded by the protective housing (4), is gas-connected to an inlet line (10), which can be blocked off by means of a first control valve (8), and to an outlet line (18), which can be blocked off by means of a second control valve (16).

9. The fuel cell arrangement (1) as claimed in claim 8, which has a compensation vessel gas-connected to its interior space (6).

10. The fuel cell arrangement (1) as claimed in claim 9, in which a particle filter (14) which is active on one side is connected between the interior space (6) and the compensation vessel.
